(19) United States
(12) Patent Application Publication
(10) Pub. No.: US 2025/0305779 A1
(43) Pub. Date: Oct. 2, 2025

(54) REFRIGERANT MANIFOLD

(71) Applicant: Hanon Systems, Daejeon (KR)

(72) Inventors: Byung Joo KIM, Daejeon (KR); Se Woong LEE, Daejeon (KR); Yang Woo LEE, Daejeon (KR)

(73) Assignee: Hanon Systems, Daejeon (KR)

(21) Appl. No.: 19/088,484

(22) Filed: Mar. 24, 2025

(30) Foreign Application Priority Data
Mar. 29, 2024 (KR) 10-2024-0042921
Feb. 18, 2025 (KR) 10-2025-0020690

(51) Int. Cl. F28F 9/04

(52) U.S. Cl. CPC F28F 9/04; F28F 2230/00

(57) ABSTRACT

The present invention relates to a refrigerant manifold, and an object of the present invention is to provide a refrigerant manifold including a reinforcement structure to improve a portion vulnerable to pressure. More specifically, another object of the present invention is to provide a refrigerant manifold in which a plurality of flow paths are formed, a rib, which is a pressure reinforcement structure, is formed on a sealing plate at a position of the flow path having a relatively large cross-sectional area or a bridge, which is a pressure reinforcement structure, is formed on a housing at a loop position formed by the flow path having a relatively large cross-sectional area.

### CROSS REFERENCE TO RELATED APPLICATION

The present application claims priority to Korean Patent Application No. 10-2025-0020690, filed on Feb. 18, 2025 and Korean Patent Application No. 10-2024-0042921, filed on Mar. 29, 2024, the entire contents of which are incorporated herein for all purposes by this reference.

### BACKGROUND OF THE INVENTION

### Field of the Invention

The present invention relates to a refrigerant manifold, and more particularly, to a structure capable of coping with a pressure-vulnerable portion of a refrigerant manifold used in a vehicle.

### Description of the Related Art

In general, various air conditioning systems, cooling systems, and the like are installed in vehicles. The air conditioning system approximately includes cooling and heating modules for adjusting air a temperature, a humidity, and the like in an interior space in which a vehicle occupant is present. The cooling system includes modules for cooling an engine, a motor, and the like to prevent the engine, the motor, and the like from being overheated. These various modules are configured to implement desired cooling, heating, and refrigerating operations by transferring heat while circulating heat exchange media such as a refrigerant and a coolant.

In particular, there are many heat exchangers intended to perform a cooling or heating process by using the refrigerant, a circulation route for the refrigerant is significantly complicated. Specifically, in case that pipes for connecting one heat exchanger to another heat exchanger and connecting another heat exchanger to still another heat exchanger are provided separately, a space of an engine room in the vehicle may become narrower because of the pipes as well as accessories configured to dispose, fix, and support the pipes. In order to solve these problems, there has been developed and widely used a refrigerant manifold that refers to a component in which the arrangement of complicated routes, through which refrigerants pass, is optimized in advance, and the routes are integrated.

Flow paths are formed in the refrigerant manifold and serve as pipes. Introduction/discharge flow ports provided at ends of the flow paths are connected to several other external devices. In addition, valves are provided to appropriately change the routes of the flow paths. Various configurations of the refrigerant manifolds are disclosed in Korean Patent Laid-Open No. 2023-0136829 (“Refrigerant Manifold for Vehicle,” Sep. 27, 2023), Korean Patent No. 2542576 (“Method of Manufacturing Manifold Main Body for Vehicle Refrigerant and Manifold Main Body for Vehicle Refrigerant Manufactured by Same,” Jun. 7, 2023), and the like.

The configuration of the flow path of the refrigerant manifold may be associated directly with a configuration of an air conditioning system provided in the vehicle, and the flow path of the refrigerant manifold may be variously designed. Meanwhile, as can be seen from the patent documents, a device configuration of the refrigerant manifold is generally configured such that at least one housing having a flow path shape is coupled to a plate stacked on and coupled to the housing and configured to define the flow path space by blocking an opened portion of the flow path shape.

FIG. 1 is a view illustrating an embodiment of a refrigerant manifold in the related art. As illustrated in FIG. 1 when viewed from the top side, the refrigerant manifold has various flow ports and various valves. In the embodiment in FIG. 1, the refrigerant manifold is configured to define a refrigerant route communicating with a water cooling condenser and a battery chiller. In addition, a three-way valve provided in the refrigerant manifold may serve to change the refrigerant routes in accordance with air conditioning modes. Further, a separate expansion valve (EXV) is provided in a route for each of the air conditioning modes, which may minimize an external device provided to complete the air conditioning mode. Further, a PTC sensor may be provided on the refrigerant manifold and immediately measure a temperature of the refrigerant passing through the refrigerant route. Of course, this configuration is just one example. As described above, the shape or arrangement of the refrigerant route formed in the refrigerant manifold, the external device connected to the refrigerant manifold, and the valve, the sensor, and the like provided in the refrigerant manifold may be variously changed.

FIG. 2 is a view illustrating several flow path portions of the refrigerant manifold in FIG. 1, i.e., a configuration view of the refrigerant manifold. As illustrated in FIG. 2, the refrigerant manifold may include an upper housing 110 having the flow path and disposed at an upper side, a lower housing 120 also having the flow path and disposed at a lower side, and a sealing plate 130 interposed between the upper and lower housings 110 and 120 configured to support the housings while defining a flow path space by blocking opening portions of the flow paths formed in the housing. In particular, FIG. 2 illustrates that several flow paths formed in the upper and lower housings 110 and 120 and denoted by \textcircled{1} to \textcircled{6}.

FIG. 3 is a view illustrating cross-sections of several flow path portions in FIG. 2. The above-mentioned flow paths are formed to connect a water cooling condenser, which is an external device, a battery chiller, or a particular expansion valve on the refrigerant manifold. In this case, the operating flow rate for optimal performance is pre-designed for each of the external devices or expansion valves, and the flow path cross-sectional area is determined according to the pre-designed values. In a specific example in FIG. 3, as illustrated, a cross-sectional area of the flow path \textcircled{1} is 199.2 mm², a cross-sectional area of the flow path \textcircled{2} is 218.6 mm², a cross-sectional area of the flow path \textcircled{3} is 79.3 mm², a cross-sectional area of the flow path \textcircled{4} is 68 mm², a cross-sectional area of the flow path \textcircled{5} is 68 mm², a cross-sectional area of the flow path \textcircled{6} is 128 mm², and the flow paths have different cross-sectional areas.

In this case, it has been reported that sealing plate parts of the flow paths \textcircled{1} and \textcircled{2} having relatively large cross-sectional areas are vulnerable to pressure in comparison with the flow paths \textcircled{3} to \textcircled{6} having relatively small cross-sectional areas. In this case, as described above, because the flow path cross-sectional area is determined in consideration of optimal performance of the external device to which the flow path is connected, the flow path cross-sectional area cannot be changed. Therefore, there is a need for an improved structure for solving these problems.

### DOCUMENTS OF RELATED ART

(Patent Document 1) Korean Patent Laid-Open No. 2023-0136829 (“Refrigerant Manifold for Vehicle,” Sep. 27, 2023)
(Patent Document 2) Korean Patent No. 2542576 (“Method of Manufacturing Manifold Main Body for Vehicle Refrigerant and Manifold Main Body for Vehicle Refrigerant Manufactured by Same,” Jun. 7, 2023)

### SUMMARY OF THE INVENTION

The present invention is proposed to solve these problems and aims to provide a refrigerant manifold including a reinforcement structure to improve a portion vulnerable to pressure. More specifically, the present invention aims to provide a refrigerant manifold in which a plurality of flow paths are formed, a rib, which is a pressure reinforcement structure, is formed on a sealing plate at a position of the flow path having a relatively large cross-sectional area or a bridge, which is a pressure reinforcement structure, is formed on a housing at a loop position formed by the flow path having a relatively large cross-sectional area.

In order to achieve the above-mentioned objects, the present invention provides a refrigerant manifold 100 including: an upper housing 110 having a plurality of flow paths and disposed at an upper side; a sealing plate 130 stacked on a lower side of the upper housing 110 and configured to define a flow path space by blocking opening portions of the flow paths formed on the upper housing 110; and a pressure reinforcement structure formed on at least one selected from the sealing plate 130, the upper housing 110, and a lower housing 120 to reinforce a coupling force between a reinforcement-required flow path and the sealing plate 130 when the flow path, which has a relatively large cross-sectional area among the plurality of flow paths, is the reinforcement-required flow path.

In addition, the refrigerant manifold 100 may further include the lower housing 120 having a plurality of flow paths and disposed and stacked on a lower side of the sealing plate 130, and the sealing plate 130 may further define a flow path space by blocking opening portions of the flow paths formed on the lower housing 120. In this case, the pressure reinforcement structure may be formed on at least one selected from the sealing plate 130, the upper housing 110, and the lower housing 120.

In addition, the reinforcement-required flow path may be a flow path in which a cross-sectional area of the flow path space is equal to or larger than a required reference area, and the required reference area may have a value within a range of 180 to 220 mm².

In this case, the pressure reinforcement structure may be a rib 135 formed in a reinforcement-required flow path region on the sealing plate 130.

In addition, the rib 135 may be formed in a shape extending in an extension direction of the reinforcement-required flow path.

In addition, the rib 135 may be formed on the sealing plate 130 and formed in a region in which an opening portion of the reinforcement-required flow path is blocked.

In addition, the rib 135 may be formed to correspond to at least one reinforcement-required flow path.

In addition, the rib 135 may be formed on the sealing plate 130 and formed in a shape protruding to the outside of the flow path space.

Alternatively, the rib 135 may be formed on the sealing plate 130 and formed in a shape depressed to the inside of the flow path space.

Alternatively, the pressure reinforcement structure may be a bridge 125 formed on the upper housing 120 or the lower housing 120 and formed at a position adjacent to the reinforcement-required flow path.

In this case, the bridge 125 may be formed in a direction and position in which the bridge suppresses torsional deformation of the reinforcement-required flow path in terms of a shape and structure.

More specifically, the bridge 125 may be formed in a shape extending in one direction, and any one end of the bridge 125 may be connected to any one end of the reinforcement-required flow path.

In addition, the bridge 125 may be formed such that a connection point between the bridge 125 and the reinforcement-required flow path is disposed at a position between any one end of the bridge 125 and any one end of the reinforcement-required flow path.

### BRIEF DESCRIPTION OF THE DRAWINGS

FIG. 1 is a view illustrating an embodiment of a refrigerant manifold in the related art.

FIG. 2 is a view illustrating several flow path portions of the refrigerant manifold in FIG. 1.

FIG. 3 is a view illustrating cross-sections of several flow path portions in FIG. 2.

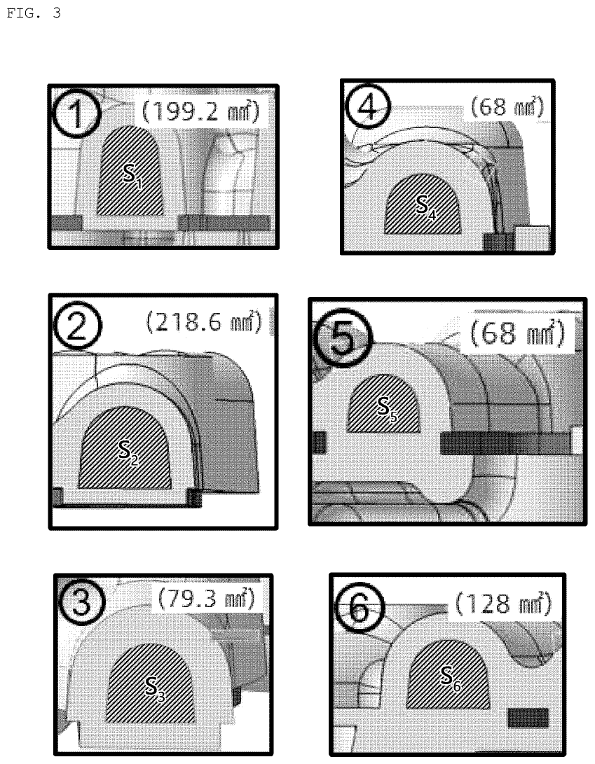

FIG. 4 is a view illustrating an embodiment of a refrigerant manifold of the present invention.

FIG. 5 is a detailed view of a sealing plate of the present invention.

FIG. 6 is a view illustrating a result of a pressure distribution simulation on the refrigerant manifold of the present invention.

### DETAILED DESCRIPTION OF THE INVENTION

Hereinafter, a refrigerant manifold according to the present invention configured as described above will be described in detail with reference to the accompanying drawings.

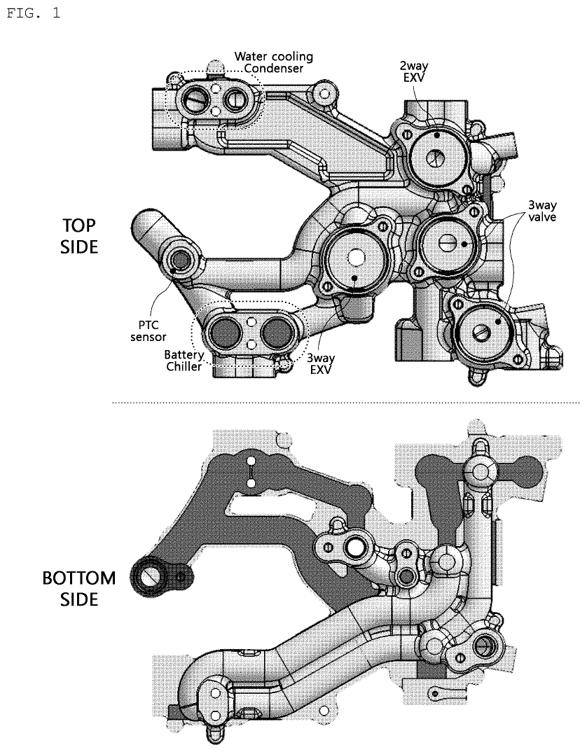

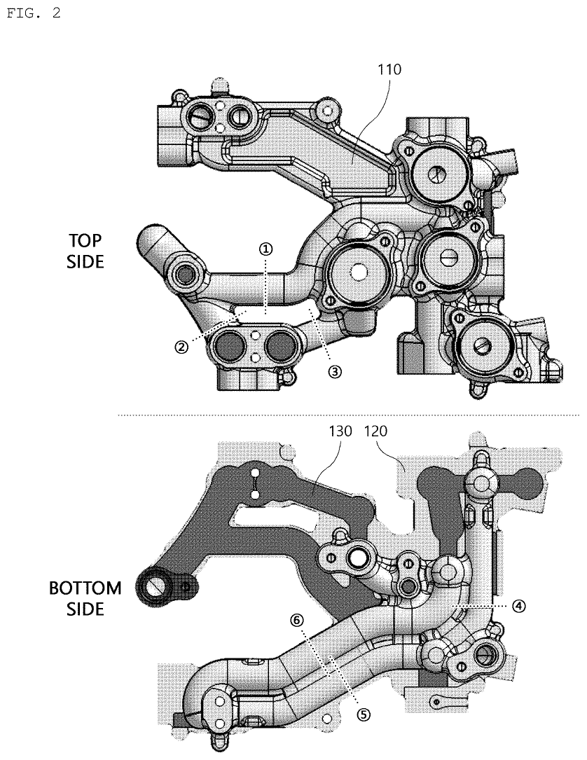

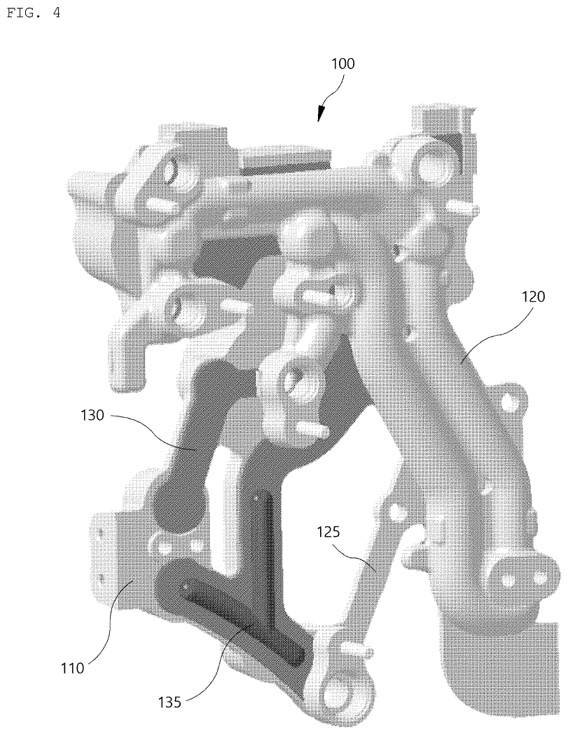

FIG. 4 illustrates an embodiment of a refrigerant manifold of the present invention. An overall configuration of a refrigerant manifold 100 illustrated in FIG. 4 is similar to that in the embodiment illustrated in FIGS. 1 and 2. That is, the refrigerant manifold 100 basically includes an upper housing 110 having a plurality of flow paths and disposed at an upper side, and a sealing plate 130 stacked on a lower side of the upper housing 110 and configured to define a flow path space by blocking opening portions of the flow paths formed in the upper housing 110 (not illustrated). In addition, as illustrated in the drawings, the refrigerant manifold 100 may further include a lower housing 120 having a plurality of flow paths and stacked and disposed on a lower side of the sealing plate 130. In this case, the sealing plate 130 may further define a flow path space by blocking opening portions of the flow paths formed in the lower housing 120. More specifically, the refrigerant manifold having the above-mentioned shape may have a structure in which two components including the upper housing 110 and the sealing plate 130 are stacked or a structure in which three components including the upper housing 110, the sealing plate 130, and the lower housing 120 are stacked. The pressure reinforcement structure of the present invention to be described below may be applied to both the structure having the two components and the structure having the three components. However, in order to more clearly describe the pressure reinforcement structures with various shapes, the embodiment will be described with reference to the refrigerant manifold with the three components. However, the present invention is not limited to the refrigerant manifold with the three components.

In this case, in case that the refrigerant manifold of the present invention has the structure in which the two components including the upper housing 110 and the sealing plate 130 are stacked, the flow path, which has a relatively large cross-sectional area among the plurality of flow paths, is referred to as a reinforcement-required flow path, and the pressure reinforcement structure may be formed on at least one selected from the sealing plate 130 and the upper housing 110 in order to reinforce a coupling force between the reinforcement-required flow path and the sealing plate 130. Alternatively, in case that the refrigerant manifold of the present invention has the structure in which the three components including the upper housing 110, the sealing plate 130, and the lower housing 120 are stacked as described above, the pressure reinforcement structure may be formed on at least one selected from the sealing plate 130, the upper housing 110, and the lower housing 120.

With reference to the comparison between FIGS. 1 and 2 illustrating the refrigerant manifold in the related art and FIG. 4 illustrating the refrigerant manifold of the present invention, the refrigerant manifolds are similar in overall configurations and almost identical in flow path configurations, extension directions, or the like. That is, the manifold in FIG. 4 may also have a problem in that the flow paths, which correspond to the flow paths \textcircled{1} and \textcircled{2} in the manifold in FIGS. 1 and 2, have large flow path cross-sectional areas and may have low pressure resistance. However, there are some differences in shapes between the refrigerant manifold in FIGS. 1 and 2 and the refrigerant manifold in FIG. 4. As described above, this is because the shapes of the refrigerant manifolds may be variously changed in accordance with the arrangement difference of external devices, internal valve, sensors, and the like. That is, it is explained in advance that the pressure reinforcement structure of the present invention to be described below may be newly applied to the refrigerant manifold in FIGS. 1 and 2 even in the case of the product that is not accurately identical in shape to the refrigerant manifold in FIGS. 1 and 2 and the refrigerant manifold in FIG. 4.

As described above, there is a problem in that the flow path, which has a relatively large cross-sectional area among the plurality of flow paths formed in the refrigerant manifold 100, has a relatively low pressure resistance because the pressure applied to the sealing plate 130 is high. Hereinafter, the flow path (the flow path having a relatively large cross-sectional area among the plurality of flow paths) will be referred to as the “reinforcement-required flow path”. As described above, in the embodiment in FIG. 4, the flow paths, which correspond to the flow paths \textcircled{1} and \textcircled{2} in the related art in FIGS. 1 and 2, are the reinforcement-required flow paths. More specifically, the reinforcement-required flow path may be a flow path in which a cross-sectional area of the flow path space is equal to or larger than a required reference area, and the required reference area may have a value within a range of 180 to 220 mm².

The refrigerant manifold 100 of the present invention includes the pressure reinforcement structure formed on at least one selected from the sealing plate 130, the upper housing 110, and the lower housing 120 in order to reinforce the coupling force between the reinforcement-required flow path and the sealing plate 130. The pressure reinforcement structure may be implemented by a rib 135 formed on the sealing plate 130, and the pressure reinforcement structure may be additionally implemented by a bridge 125 formed on the upper housing 110 or the lower housing 120. Hereinafter, the pressure reinforcement structure will be described in more detail.

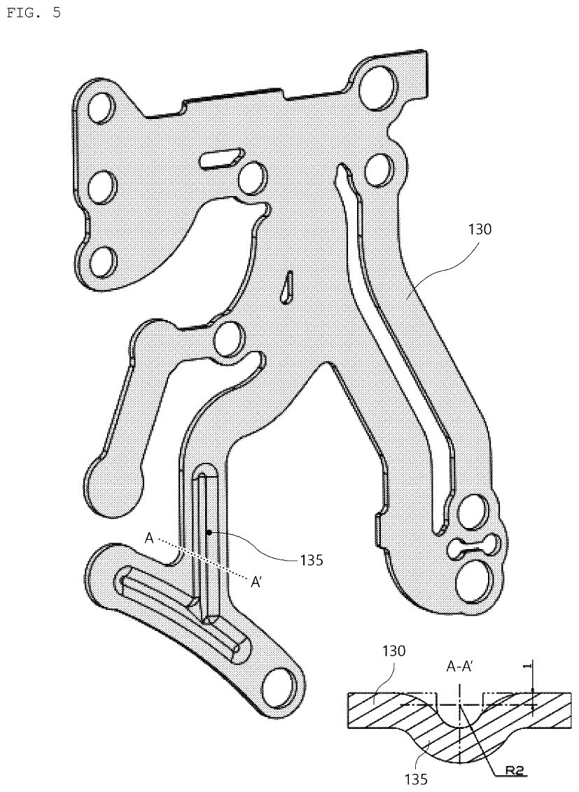

FIG. 5 separately illustrates only the sealing plate of the present invention in detail. The pressure reinforcement structure implemented by the rib 135 will be described in more detail with reference to FIG. 5.

In the embodiment, the pressure reinforcement structure may be the rib 135 formed on the sealing plate 130 and formed in a reinforcement-required flow path region. As illustrated, the rib 135 is formed in a shape extending in an extension direction of the reinforcement-required flow path. Of course, naturally, the rib 135 is formed in a region on the sealing plate 130 in which an opening portion of the reinforcement-required flow path is blocked.

The rib 135 may be easily implemented by pressing the sealing plate 130 having a flat shape. When the flow path space is formed as the sealing plate 130 blocks the opening portions of the flow paths on the upper and lower housings 110 and 120, the pressure increases as the flow path space is large and a flow rate is high. Therefore, the coupling between the sealing plate 130 and the upper and lower housings 110 and 120 may be weakened. That is, the pressure of the refrigerant in the flow path space is applied to push the sealing plate 130. In this case, when the rib 135 is present on the sealing plate 130 in the reinforcement-required flow path region, the pressure of the refrigerant in the flow path space may not only be applied to push the sealing plate 130 but also be dispersed by the rib 135. In addition, because the rib 135 is present, an area of the sealing plate 130, which receives the refrigerant pressure, is increased, and thus a magnitude of a force by which the sealing plate 130 is pushed is naturally decreased. That is, collectively, because the force by which the sealing plate 130 is pushed is decreased, the coupling force of the sealing plate 130 is reinforced by the presence of the rib 135, such that the pressure resistance in the corresponding flow path (i.e., the reinforcement-required flow path) may be increased.

One reinforcement-required flow path may be present in one refrigerant manifold 100. As shown in the example in the related art in FIGS. 1 and 2, two or more reinforcement-required flow paths may be present. The rib 135 may be formed to correspond to at least one reinforcement-required flow path. That is, in case that one reinforcement-required flow path is provided, one rib 135 may also be formed. In case that a plurality of reinforcement-required flow paths are provided, a plurality of ribs 135 may also be formed. In the embodiment in FIG. 4, two reinforcement-required flow paths are provided, two ribs are formed, and the two reinforcement-required flow paths are connected to each other, such that the two ribs 135 are also naturally connected to each other.

Meanwhile, the rib 135 may have any one of a protruding shape and a depressed shape in consideration of only an effect of dispersing the pressure and increasing the pressure area as described above. That is, as illustrated in FIGS. 4 and 5, the rib 135 may be formed in a shape protruding from the sealing plate 130 to the outside of the flow path space. Alternatively, (although not illustrated), the rib 135 may be formed in a shape depressed from the sealing plate 130 to the inside of the flow path space.

In case that the rib 135 is formed in a shape protruding outward, the flow path space is increased, unlike the case in which the rib 135 is formed in a depressed shape. In this case, as described above, the flow path cross-sectional area of the flow path is determined in advance in consideration of optimal performance of a device connected to the flow path. Therefore, an original size of the flow path cross-sectional area may be adjusted by reducing a size of the flow path on the housing by the flow path cross-sectional area added by the presence of the rib 135. In this case, in consideration of a configuration in which a thickness of the flow path wall surface on the housing is larger than a thickness of the sealing plate 130, an overall volume and weight of the refrigerant manifold 100 may be reduced by reducing the size of the flow path on the housing. Of course, the rib 135 may protrude, but a protruding height of the rib 135 is anyway smaller than a height of the housing and does not affect the overall volume at all. As a result, in case that the rib 135 is formed, it is possible to obtain not only an effect of improving the pressure resistance but also an additional effect of reducing the overall volume and weight of the refrigerant manifold 100.

Meanwhile, the reason why the coupling force of the sealing plate 130 is decreased is that stress is applied to a coupling portion as the sealing plate 130 is deformed by the pressure of the refrigerant flowing in the flow path space. That is, the configuration of preventing deformation of the sealing plate 130 assists in improving pressure resistance.

In consideration of this configuration, the pressure reinforcement structure may be the bridge 125 formed on the upper housing 120 or the lower housing 120 is provided at a position adjacent to the reinforcement-required flow path. In this case, the bridge 125 is formed in a direction and position in which the bridge 125 suppresses torsional deformation of the reinforcement-required flow path in terms of the shape and structure. More specifically, the bridge 125 may be formed in a shape extending in one direction, and any one end of the bridge 125 may be connected to any one end of the reinforcement-required flow path. In addition, a connection point between the bridge 125 and the reinforcement-required flow path may be disposed at a position between any one end of the bridge 125 and any one end of the reinforcement-required flow path. Another end of the bridge 125 may be connected to the upper housing 110 or the lower housing 120, and the housing, to which the bridge 125 is connected to, may be the housing other than the housing having the reinforcement-required flow path.

One specific embodiment of this shape is illustrated in FIG. 4. In the example in FIG. 4, the flow paths corresponding to the flow paths \textcircled{1} and \textcircled{2} in FIG. 1 are the reinforcement-required flow paths, and the rib 135 is formed on the reinforcement-required flow path. In this case, a part of the sealing plate 130 corresponding to the two reinforcement-required flow paths has a shape corresponding to two sides of an approximately quadrangular shape. Another part of the sealing plate 130 extending and connected to one of the two reinforcement-required flow paths has a shape corresponding to one of the remaining two sides of the quadrangular shape. Therefore, as illustrated in FIG. 4, the bridge 125 may be formed in the direction and position corresponding to the one side that completes the quadrangular shape. These shapes satisfy all the shape conditions of the above-mentioned bridge 125. In addition, with this shape, a part of the sealing plate 130 including the reinforcement-required flow path completes the closed quadrangular shape together with the bridge 125, such that a structurally stable shape is implemented. As a result, the bridge 125 may prevent torsional damage to a part of the sealing plate 130 including the reinforcement-required flow path.

The bridge 125 may be formed to have a shape, a direction, a position, and the like in accordance with the shape of the refrigerant manifold 100, the position of the reinforcement-required flow path, and the number of reinforcement-required flow paths. However, in many cases, a large number of flow ports connected to the external device are formed in the upper housing 110, and devices, such as the valve, the sensor, and the like, directly provided are also provided. Therefore, the bridge 125 may be formed on the lower housing 120 having a relatively simple structure.

However, in case that the bridge 125 is formed, there is a concern that the weight of the refrigerant manifold 100 may be increased, which may cause an inadvertent effect. In consideration of this situation, the rib 135 may be most preferentially considered as the pressure reinforcement structure, and the bridge 125 may be additionally provided when the pressure resistance cannot be sufficiently obtained only by the rib 135.

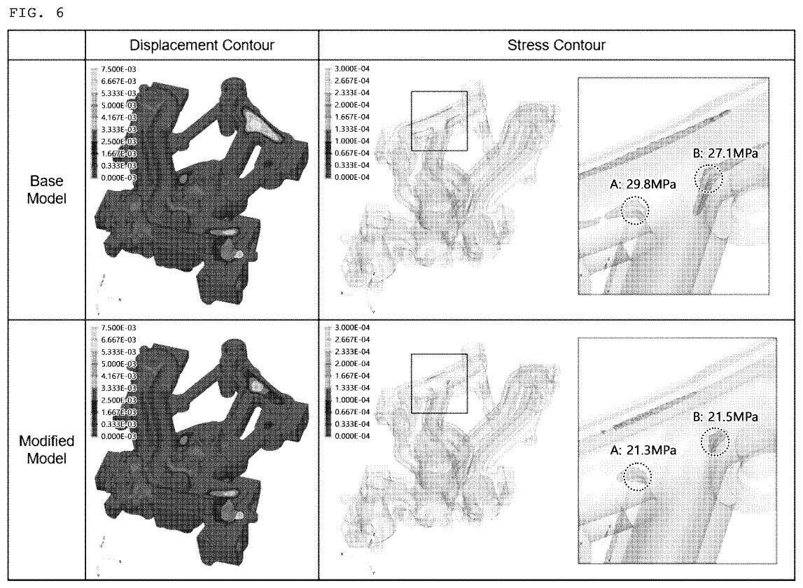

FIG. 6 is a view illustrating a result of a pressure distribution simulation on the refrigerant manifold of the present invention. “Base Model” at the top side of FIG. 6 is a refrigerant manifold (i.e., a refrigerant manifold in the related art) almost similar to that in FIG. 4 but having no rib on the sealing plate, and “Modified Model” at the bottom side of FIG. 6 is a refrigerant manifold of the embodiment in FIG. 4, i.e., the present invention having the rib on the sealing plate. Hereinafter, “Base Model” will be referred to as ‘the related art’, and “Modified Model” will be referred to as ‘the present invention’.

With reference to the “Displacement Contour” column, it is clearly ascertained that significant deformation occurs in the region of the flow paths \textcircled{1} and \textcircled{2} to the extent that a high-stress region (light color) is clearly visible in the related art, whereas in the case of the present invention, the rib is formed, such that the deformation amount in the regions of the flow paths \textcircled{1} and \textcircled{2} is significantly reduced and becomes similar to a deformation amount in another flow path region. In addition, with reference to the “Stress Contour” column, the enlarged views are particularly compared. It is clearly ascertained that in the case of the related art, high stress of about 29.8 MPa and 27.1 MPa is applied at points A and B at the periphery of the connection portion between the flow paths \textcircled{1} and \textcircled{2}, whereas in the case of the present invention, stress is about 21.3 MPa and 21.5 MPa at the same positions, and the stress is reduced by 8.5 MPa and 5.6 MPa in comparison with the related art.

According to the present invention, in the refrigerant manifold, the plurality of flow paths are formed, the rib, which is the pressure reinforcement structure, is formed on the sealing plate at the position of the flow path having a relatively large cross-sectional area or the bridge, which is a pressure reinforcement structure, is formed on a housing at a loop position formed by the flow path having a relatively large cross-sectional area, such that the pressure resistance of the sealing plate in the corresponding flow paths relatively vulnerable to pressure may be reinforced.

In particular, in the embodiment in which the rib is formed on the sealing plate, the flow path cross-sectional area may be increased when the rib is formed to protrude outward. In this case, because the design-required cross-sectional area of the flow path is determined in advance, the flow path cross-sectional area formed on the housing may be reduced by the flow path cross-sectional area added by the rib. As a result, the flow path portion volume of the housing may be reduced, which may reduce the volume and weight of the refrigerant manifold.

The present invention is not limited to the above embodiments, and the scope of application is diverse. Of course, various modifications and implementations made by any person skilled in the art to which the present invention pertains without departing from the subject matter of the present invention claimed in the claims.

DESCRIPTION OF REFERENCE NUMERALS

| | |
|---|---|
| 100: Refrigerant manifold | 110: Upper housing |
| 120: Lower housing | 125: Bridge |
| 130: Sealing plate | 135: Rib |

What is claimed is:

1. A refrigerant manifold comprising:
an upper housing having a plurality of flow paths and disposed at an upper side;
a sealing plate stacked on a lower side of the upper housing and configured to define a flow path space by blocking opening portions of the flow paths formed on the upper housing; and
a pressure reinforcement structure formed on at least one selected from the sealing plate and the upper housing to reinforce a coupling force between a reinforcement-required flow path and the sealing plate when the flow path, which has a relatively large cross-sectional area among the plurality of flow paths, is the reinforcement-required flow path.

2. The refrigerant manifold of claim 1, wherein the refrigerant manifold further comprises a lower housing having a plurality of flow paths and disposed and stacked on a lower side of the sealing plate, and
wherein the sealing plate further defines a flow path space by blocking opening portions of the flow paths formed on the lower housing.

3. The refrigerant manifold of claim 2, wherein the pressure reinforcement structure is formed on at least one selected from the sealing plate, the upper housing, and the lower housing.

4. The refrigerant manifold of claim 1, wherein the reinforcement-required flow path is a flow path in which a cross-sectional area of the flow path space is equal to or larger than a required reference area, and the required reference area has a value within a range of 180 to 220 mm².

5. The refrigerant manifold of claim 1, wherein the pressure reinforcement structure is a rib formed in a reinforcement-required flow path region on the sealing plate.

6. The refrigerant manifold of claim 5, wherein the rib is formed in a shape extending in an extension direction of the reinforcement-required flow path.

7. The refrigerant manifold of claim 6, wherein the rib is formed on the sealing plate and formed in a region in which an opening portion of the reinforcement-required flow path is blocked.

8. The refrigerant manifold of claim 7, wherein the rib is formed to correspond to at least one reinforcement-required flow path.

9. The refrigerant manifold of claim 7, wherein the rib is formed on the sealing plate and formed in a shape protruding to the outside of the flow path space.

10. The refrigerant manifold of claim 7, wherein the rib is formed on the sealing plate and formed in a shape depressed to the inside of the flow path space.

11. The refrigerant manifold of claim 1, wherein the pressure reinforcement structure is a bridge formed on the upper housing or a lower housing and formed at a position adjacent to the reinforcement-required flow path.

12. The refrigerant manifold of claim 11, wherein the bridge is formed in a direction and position in which the bridge suppresses torsional deformation of the reinforcement-required flow path in terms of a shape and structure.

13. The refrigerant manifold of claim 12, wherein the bridge is formed in a shape extending in one direction, and any one end of the bridge is connected to any one end of the reinforcement-required flow path.

14. The refrigerant manifold of claim 13, wherein the bridge is formed such that a connection point between the bridge and the reinforcement-required flow path is disposed at a position between any one end of the bridge and any one end of the reinforcement-required flow path.

15. The refrigerant manifold of claim 13, wherein the bridge is formed such that another end of the bridge is connected to the upper housing or the lower housing, and the housing, to which the bridge is connected, is the housing other than the housing having the reinforcement-required flow path.
